(19) United States
(12) Patent Application Publication
(10) Pub. No.: US 2025/0225780 A1
(43) Pub. Date: Jul. 10, 2025

(54) NEURAL NETWORK TUNING USING TEXT ENCODER

(71) Applicant: Snap Inc., Santa Monica, CA (US)

(72) Inventors: Erli Ding, Santa Monica, CA (US); Ju Hu, Los Angeles, CA (US); Yerlan Idelbayev, Los Angeles, CA (US); Anil Kag, Los Angeles, CA (US); Yanyu Li, Quincy, MA (US); Jian Ren, Hermosa Beach, CA (US); Dhritiman Sagar, New York, NY (US); Sergey Tulyakov, Santa Monica, CA (US)

(21) Appl. No.: 18/407,232

(22) Filed: Jan. 8, 2024

(51) Int. Cl. G06V 10/82; G06N 3/045

(52) U.S. Cl. CPC G06V 10/82; G06N 3/045

(57) ABSTRACT

Methods, systems, and non-transitory computer-readable mediums for tuning a generative text-to-image neural network. Text prompts are processed using a pre-trained text encoder to obtain embedded text prompts, which are used by a pre-trained diffusion model to generate images. Reward scores are iteratively determined for the images while the pre-trained diffusion model is fixed and weights of the pre-trained text encoder are updated to fine tune the neural network in order to improve the quality of generated images. Additionally, reward scores for the images can then be determined with the updated weights of the text encoder fixed to update weights of the pre-trained diffusion model to further fine tune the neural network.

### TECHNICAL FIELD

Examples set forth herein generally relate to tuning a generative neural network and, in particular, to tuning a text-to-image generative neural network by tuning a text encoder of the neural network based on aesthetic quality of generated images.

### BACKGROUND

Diffusion-based text-to-image generative models, such as Stable Diffusion (SD) used for image editing, super-resolution, and video synthesis, are revolutionizing the field of content generation, enabling significant advancements in areas like image editing and video synthesis. Despite their capabilities, these models have limitations. For example, it is still challenging to synthesize an image that aligns well with the input text, and multiple runs with carefully crafted prompts are often needed to achieve satisfactory results. New techniques are in demand to efficiently improve the results obtainable with diffusion-based text-to-image generative models.

### BRIEF DESCRIPTION OF THE DRAWINGS

In the drawings, which are not necessarily drawn to scale, like numerals may describe similar components in different views. Some nonlimiting examples are illustrated in the figures of the accompanying drawings in which:

FIG. 1 illustrates a diagram of a general process for tuning a text-to-image generative neural network.

FIG. 2 is a flowchart depicting a series of acts for tuning a text-to-image generative neural network.

FIG. 3 is a block diagram of an example computing device for implementing one or more examples of the present disclosure.

### DETAILED DESCRIPTION

Various implementations and details are described with reference to examples for tuning a generative text-to-image neural network that includes a pre-trained text encoder and a pre-trained diffusion model. Text prompts are processed using the pre-trained text encoder to obtain embedded text prompts, which are used by the pre-trained diffusion model to generate images. Reward scores are iteratively determined for the images while the pre-trained diffusion model is fixed and weights of the pre-trained text encoder are updated responsive to the reward scores to fine tune the neural network in order to improve the quality of generated images. Additionally, reward scores for the images can then be determined with the updated weights of the text encoder fixed to update weights of the pre-trained diffusion model responsive to the reward scores to further fine tune the neural network.

In one example, instead of replacing the text encoder used in a Stable Diffusion (SD) network architecture (e.g., Contrastive Language-Image Pre-Training; CLIP) with another large language model, the present disclosure fine tunes the pre-trained text encoder through the use of image quality reward techniques, which leads to improvements in quantitative benchmarks and human assessments. Techniques described herein also empower controllable image generation through the interpolation of different text encoders fine-tuned with various rewards. The techniques described herein for fine tuning the text encoder can be combined with techniques for fine tuning the diffusion model in a neural network architecture (e.g., a U-shaped encoder-decoder network architecture; UNet) to further improve generative image quality.

The techniques described herein utilize machine learning and various neural networks in various examples. The term “machine learning,” as used herein, refers to the process of constructing and implementing algorithms that can learn from and make predictions on data. In general, machine learning may operate by building models from example inputs, such as a training set of text-image pairs, to make data-driven predictions or decisions. Machine learning can include neural networks and/or machine-learning models.

As used herein, the term “neural network” refers to a machine learning model that can be tuned (e.g., trained) based on inputs to approximate unknown functions. In particular, the term neural network can include a model of interconnected neurons that communicate and learn to approximate complex functions and generate outputs based on a plurality of inputs provided to the model. For instance, the term neural network includes an algorithm (or set of algorithms) that implements deep learning techniques that utilize a set of algorithms to model high-level abstractions in data using supervisory data to tune parameters of the neural network.

In addition, in one or more examples, the term neural network can include deep convolutional neural networks (i.e., “CNNs”), or other types of deep neural networks. The description and figures below generally refer to a CNN, which includes lower layers (e.g., convolutional, deconvolutional, and pooling layers), and higher layers (e.g., fully-connected layers and classifiers).

As used herein, the term “loss function” or “loss model” refers to a function that indicates error loss between feature vectors and/or probability vectors in multi-dimensional vector space. A machine-learning algorithm (e.g., neural network) can repetitively train to minimize and/or maximize error loss based on ground truths. For example, the loss function provides feedback, which is back propagated, to one or more layers of a neural network to tune/fine-tune those layers. Examples of loss functions include a sigmoid unit function, a SoftMax classifier with cross-entropy loss, a residual loss function, a perceptual loss function, a total variance loss function, a texture loss function, a hinge loss function, and a least squares loss function.

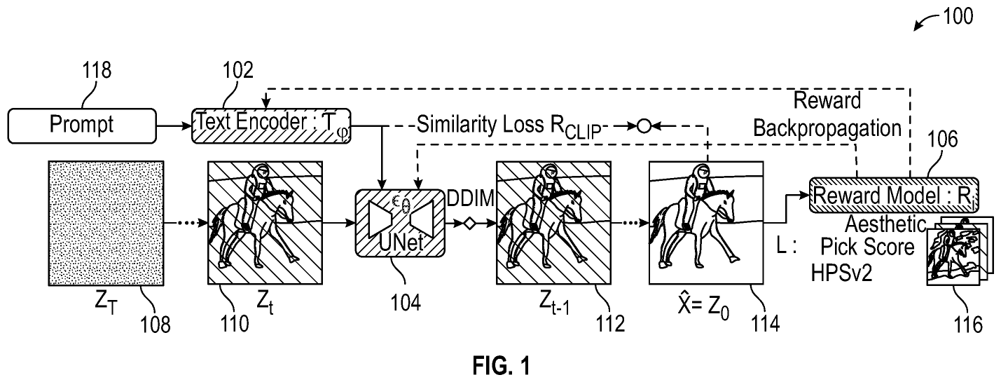

FIG. 1 illustrates a general process 100 for training a text-to-image generative neural network including a text encoder 102, a diffusion model 104, and a reward model 106. In an example, the text encoder 102 is a conventional pre-trained text encoder (e.g., CLIP) and the diffusion model 104 is a conventional pre-trained diffusion model (e.g., SD such as UNet). The reward model 106 includes one or more models for analyzing the quality of images generated by the diffusion model 104 based on text prompts 118 input to the text encoder 102.

Though trained on large-scale datasets, SD still faces two challenges. First, it often produces images that do not align well with the provided prompts. Second, generating visually pleasing images frequently requires multiple runs with different random seeds and manual prompt engineering. To address the first challenge, others have substituted the CLIP text encoder used in conventional SD implementations with other large language models like T5 and SDXL. Language models such as the T5 model have an order of magnitude more parameters than CLIP, resulting in additional storage and computation overhead. To address the second challenge, others have fine-tuned the pre-trained UNet from SD on paired image-caption datasets. Nonetheless, models trained on constrained datasets may still struggle to generate high-quality images for unseen prompts.

Stepping back and considering the pipeline of text-to-image generation, the inventors recognized that the text encoder and the diffusion model (e.g., UNet) both influence the quality of the synthesized images. Unlike conventional techniques, the examples described herein fine-tune a pre-trained text encoder used in the generative model to enhance performance, resulting in better image quality and improved text-image alignment.

Examples provided herein utilize an end-to-end fine-tuning technique to enhance the pre-trained text encoder. Instead of relying on paired text-image datasets, reward function models (e.g., models trained to automatically assess the image quality like aesthetics models, and models that understand the performance of text-to-image models) can be used to improve the text encoder in a differentiable manner. Using text prompts during training, the techniques described herein enable on-the-fly synthesis of training images and alleviates the burden of storing and loading large-scale image datasets.

The examples described herein provide improvements in image quality and text-image alignment for a well-trained text-to-image diffusion model. Compared with using larger text encoders, e.g., T5 and SDXL, this avoids extra computation and storage overhead. Compared with prompt engineering, this also reduces the risks of generating irrelevant content.

Thus, the examples provide an effective and stable text encoder fine-tuning pipeline supervised by reward functions (which are publicly available). Alignment constraints may be implemented to preserve the capability and generality of the large-scale CLIP-pretrained text encoder, making the approach described herein the first generic reward fine-tuning paradigm among concurrent arts. Furthermore, the text encoder fine tuning described herein is orthogonal to UNet fine tuning and, thus, further quality improvements may be obtained by subsequently fine-tuning UNet after fine tuning the text encoder.

Assessing the performance of text-to-image models is challenging. Early methods used automatic metrics like Fréchet inception distance (FID) to gauge image quality and CLIP scores to assess text-image alignment. However, subsequent studies have indicated that these scores exhibit limited correlation with human perception. To address such discrepancies, recent research has delved into training models specifically designed for evaluating image quality for text-to-image models. Examples include ImageReward and human preference scores, which leverage human-annotated images to train the quality estimation models. The examples described herein leverage these models, along with an image aesthetics model, as reward functions for enhancing visual quality and text-image alignment for the text-to-image diffusion models.

In response to the inherent limitations of pre-trained diffusion models, various strategies have been proposed to elevate generation quality, focusing on aspects like image color, composition, and background. One direction utilizes reinforcement learning to fine-tune the diffusion model. Another area fine-tunes the diffusion models with reward function in a differentiable manner. Following this trend, later studies extended the pipeline to trainable LoRA weights with the text-to-image models. Unlike these strategies and trends, examples described herein delve into the novel exploration of fine-tuning the text-encoder using reward functions in a differentiable manner, a dimension that has not been previously explored.

Another avenue of research focuses on enhancing user-provided text to generate images of enhanced quality. Researchers use large language models, such as LLAMA, to refine or optimize text prompts. By improving the quality of prompts, the text-to-image model can synthesize higher-quality images. However, the utilization of additional language models introduces increased computational and storage demands. By fine-tuning the text encoder in accordance with examples provided herein the model can gain a more nuanced understanding of the given text prompts, obviating the need for additional language models and their associated overhead.

Referring to FIG. 1, an end-to-end text encoder fine-tuning process 100 is based on prompt data and reward functions. Text prompts 118 from a user are forwarded to a previously trained text encoder 102. The text encoder 102 embeds the text prompts 118, which are forwarded to a diffusion model 104 (previously trained with text-image pairs). The diffusion model 104 may be a conventional SD diffusion model such as a denoising diffusion probabilistic model (DDPM) or denoising diffusion implicit model (DDIM), which produces intermediate diffusions in latent spaces 110 and 112—leading to a text-image pair diffusion 108 and an output image 114, respectively. The reward model 106 computes reward loss scores 116, which are backward propagated to update the weights of the previously trained text encoder 102 (and optionally the previously trained diffusion model 104) during a fine-tuning secondary training process to maximize the reward score from the reward model 106.

The diffusion model 104 converts a real data distribution, i.e., text-image pairs, into a noisy distribution 108 (Z_{T}), e.g., Gaussian distribution, through a reversible denoising process. To reduce the computation cost, due to the number of denoising steps, latent diffusion models (LDM) conduct the denoising process in latent image diffusion spaces 110 (Zₜ) and 112 (Zₜ₋₁), using a stable diffusion architecture such as UNet, where real data is encoded through a variational autoencoder (VAE). The latent image data space 112 is decoded into an image 114 during inference time.

Details for one example of the process 100 are now described. Formally, let (x, p) be the real-image and prompt data pair (for notation simplicity, x also represents the data encoded by a VAE) drawn from the distribution p_{data} (x,p), ϵ_{θ}(⋅) be the diffusion model with parameters θ, T_{φ}(⋅) be the text encoder parameterized by φ, training the text-to-image LDM under the objective of noise prediction can be formulated as follows in Equation 1:

$${min}_{θ} {𝔼}_{t \sim U [ 0 , 1 ] , ( x , p ) \sim {p}_{data} ( x , p ) , ϵ \sim 𝒩 ( O , I )} {‖ {\hat{ϵ}}_{θ} ( t , {z}_{t} , c ) - ϵ ‖}_{2}^{2} \qquad ( 1 )$$

where ϵ is the ground-truth noise; t is the time step; zₜ=αₜx+σₜϵ is the noised sample with at representing the signal and σₜ representing the noise, that are both decided by a scheduler; and c is the textual embedding such that c=T_{φ}(p).

During training of the conventional SD models, the weights of the text encoder T are fixed. For example, the text encoder from the CLIP model is optimized through the contrastive objective between text and images. Therefore, it does not necessarily learn the semantic meaning of the prompt, resulting in the generated image not necessarily aligning well with the given prompt using such a text encoder.

After the text-to-image diffusion model is trained, the system samples Gaussian noises for the same text prompt using numerous samplers, such as DDIM, that iteratively samples from t to its previous step t′ with the following denoising process represented in Equation 2, until t becomes 0:

$${z}_{t}^{′} = {α}_{t}^{′} \frac{{z}_{t} - {σ}_{t} {\hat{ϵ}}_{θ} ( t , {z}_{t} , c )}{{α}_{t}} + {σ}_{t}^{′} {\hat{ϵ}}_{θ} ( t , {z}_{t} , c ) \qquad ( 2 )$$

One approach to improving the generation quality during the sampling stage is through classifier-free guidance (CFG). By adjusting the guidance scale within CFG, the system can further balance the trade-off between the fidelity and the text-image alignment of the synthesized image. Specifically, for the process of text-conditioned image generation, by letting ø denote the null text input, classifier-free guidance can be defined as follows in Equation 3:

$$\hat{ϵ} = {\hat{ϵ}}_{θ} ( t , {z}_{t} , c ) - ( - 1 ) {\hat{ϵ}}_{θ} ( t , {z}_{t} , ∅ ) \qquad ( 3 )$$

Two techniques for fine-tuning the text encoder by reward guidance include direct finetuning with reward and prompt-based reward finetuning. These techniques are described, in turn, below.

For direct fine-tuning with reward, in an example normal training process of diffusion models, a system samples from real data and random noise to perform forward diffusion, zₜ=αₜ x+σₜ ϵ, upon which the denoising UNet, ϵ_{θ}(⋅), makes a (noise) prediction. Instead of calculating z_{t′} as in Equation 2, the system alternatively predicts the original data as follows in Equation 4:

$$X = \frac{{z}_{t} - {σ}_{t} {\hat{ϵ}}_{θ} ( t , {z}_{t} , T φ ( p ) )}{{α}_{t}} \qquad ( 4 )$$

where \hat{x} is the estimated real sample, which is an image for the text-to-image diffusion model.

This formulation works for both pixel-space and latent-space diffusion models, where, in latent diffusion, \hat{x} is post-processed by the VAE decoder before feeding into reward models. Since the decoding process is also differentiable, for simplicity, this process is omitted in formulations and \hat{x} is the predicted image. With \hat{x} obtained, the system uses public reward models, denoted as R, to assess the quality of the generated image. Therefore, to improve the text encoder used in the diffusion model, the system optimizes the text encoder's weights, i.e., φ in T, with the learning objective of maximizing the quality scores predicted by the reward models.

In one example, the system employs both image-based reward model R(\hat{x}), e.g., an aesthetic score predictor, and text-image alignment-based reward models R(\hat{x},p), e.g., human preference score version 2 (HPSV2) and PickScore. Consequently, the loss function for maximizing the reward scores can be defined as follows in equation 5:

$$ℒ ( φ ) = - R ( \hat{x} , / p ) = - R ( \frac{{z}_{t} - {σ}_{t} {ϵ}_{θ} ( t , {z}_{t} , T φ ( p ) )}{{α}_{t}} , / p ) \qquad ( 5 )$$

When optimizing Equation 5, the weights for all reward models and the UNet model are fixed, while only the weights in the CLIP text encoder are modified in one example.

For prompt-based reward finetuning, given a specific text prompt, p, and an initial noise z_{T}, the denoising process in Equation 2 is iteratively solved to obtain \hat{x}=z₀, which can then be substituted into Equation 5 to compute the reward scores. Consequently, the system can precisely predict \hat{x}, and also eliminate the need for paired text-image data by performing the reward fine-tuning with only prompts and a pre-defined denoising schedule, e.g., a 25-steps DDIM. Since each timestep in the training process is differentiable, the gradient to update φ in T can be calculated using, for example, the chain rule of Equation 6 as follows:

$$\frac{\partial ℒ}{\partial φ} = - \frac{\partial ℛ}{\partial \hat{x}} \cdot {\prod }_{t = 0}^{t} \frac{\partial {α}_{t} , [ \frac{{z}_{t} - {σ}_{t} {\hat{ϵ}}_{θ} ( t , {z}_{t} , T φ ( p ) )}{{α}_{t}}}{\partial T φ ( p )} \cdot \frac{\partial T φ ( p )}{{\partial }_{φ}} \qquad ( 6 )$$

Solving Equation 6 may be memory infeasible for early (noisy) timesteps, i.e., t={T,T−1, . . . }, as the computation graph accumulates in the backward chain. Gradient checkpointing may be utilized to trade memory for computational efficiency. Intuitively, the intermediate results are re-calculated on the fly. Thus, the training can be viewed as solving one step at a time. With gradient checkpointing, however, the system can technically train the text encoder with respect to each timestep. The proposed prompt-based reward finetuning is further illustrated in the following algorithm:

Algorithm

```
Obtain: pretrained UNet \hat{ϵ}_{θ}; pretrained text encoder Tφ; prompt set: [symbol] {p}
Ensure: Tφ (optionially \hat{ϵ}_{θ} if finetuing UNet) converges and maximizes [symbol]
ₜₒₜₐₗ
  →Perform text encoder fine-tuning
  Freeze UNet \hat{ϵ}_{θ} and reward models [symbol] ᵢ, activate Tφ.
  while [symbol] ₜₒₜₐₗ not converged do
    Sample p from [symbol]  ; t = T
    while t > 0 do
      ${z}_{t - 1} ← {α}_{{t}^{′}} \frac{{z}_{t} - {σ}_{t} {\hat{ϵ}}_{θ} ( t , {z}_{t} , T φ ( p ) )}{{α}_{t}} + {σ}_{{t}^{′}} {\hat{ϵ}}_{θ} ( t , {z}_{t} , T φ ( p ) )$
    end while
    x ← z₀
    ${ℒ}_{total} ← - {\sum }_{i} {γ}_{i} {ℛ}_{i} ( \hat{x} , \cdot / p )$
    Backward [symbol] ₜₒₜₐₗ and update Tφ for last K steps.
  end while
  → Perform UNet finetuning
  Freeze Tφ and reward models Rᵢ, activate UNet \hat{ϵ}_{θ}
  Repeat reward training until convergence
```

The reward losses [symbol] ₜₒₜₐₗ can be weighted by γ and linearly combined as shown in Equation 7 as follows:

$${ℒ}_{total} = {\sum }_{i} {ℒ}_{i} = - {\sum }_{i} {γ}_{i} {ℛ}_{i} ( \hat{x} , . / p ) \qquad ( 7 )$$

The different reward functions with various weights can be combined. However, some reward functions are by nature limited in terms of their capability and training scale. As a result, fine-tuning with only one reward can result in catastrophic forgetting and mode collapse.

To address this issue, in one example the CLIP space similarity is set as an always-online constraint as follows in Equation 8:

$${ℛ}_{CLIP} = cosine - sim ( ( \hat{x} ) , T φ ( p ) ) \qquad ( 8 )$$

and ensuring γ_{CLIP}>0 in Equation 7. Specifically, the system in this example maximizes the cosine similarity between the textual embeddings and image embeddings. The textual embedding is obtained in forward propagation, while the image embedding is calculated by sending the predicted image \hat{x} to the image encoder [symbol] of CLIP. The original text encoder T_{φ} is pre-trained in large-scale contrastive learning paired with the image encoder [symbol] . As a result, the CLIP constraint preserves the coherence of the fine-tuned text embedding and the original image domain, ensuring capability and generalization.

The fine-tuning approaches for the text encoder are orthogonal to UNet reward fine-tuning, meaning that the text encoder and UNet can be optimized under similar learning objectives to further improve performance. Examples of the fine-tuned text encoder described herein can seamlessly fit the pre-trained UNet in Stable Diffusion and can be used for other downstream tasks besides text-to-image generation. To preserve this characteristic and avoid domain shifting, the UNet can be fine-tuned by freezing the fine-tuned text encoder T_{φ}. The learning objective for UNet is similar to Equation 6, where parameters θ of \hat{∈}_{θ}, are optimized instead of φ.

Instead of adjusting reward weights γᵢ in Equation 7, alternatively the system can train dedicated text encoders optimized for each reward, and mix-and-match them in the inference phase for flexible and controllable generation.

Examples described herein provide a stable and powerful framework to fine-tune the pre-trained text encoder to improve the text-to-image generation. With only prompt dataset and pre-defined reward functions, example systems can enhance the generative quality compared to the pre-trained text-to-image models, reinforcement learning-based approach, and prompt engineering. To stabilize the reward fine-tuning process and avoid mode collapse, a novel similarity-constrained paradigm may be implemented.

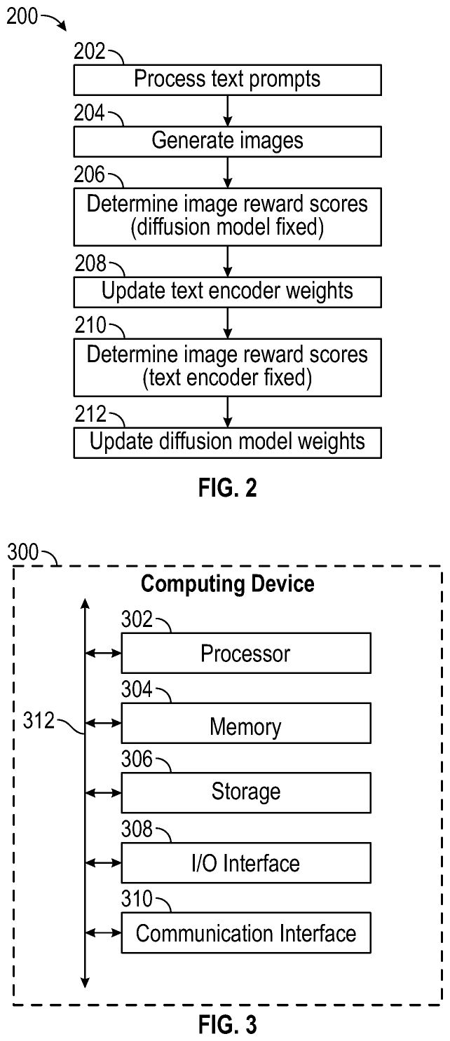

FIG. 2 depicts a flowchart 200 including blocks reciting a series of acts. In various examples, the text-to-image generative neural network described with reference to FIG. 1 implements the acts. The text-to-image generative neural network and the series of acts can be implemented by one or more computing devices, such as one or more server devices, one or more client devices, or a combination of server devices and client devices. In addition, the series of acts of FIG. 2 can be implemented on one or more computing devices, such as the computing device 300 (FIG. 3).

While FIG. 2 illustrates a series of acts according to particular examples, alternative examples may at least one of omit, add to, reorder, or modify any of the acts shown. The series of acts of FIG. 2 can be performed as part of a method. Alternatively, a non-transitory computer-readable medium can comprise instructions that, when executed by one or more processors, cause a computing device (e.g., at least one of a client device or a server device) to perform the series of acts of FIG. 2. In still further examples, a system performs the series of acts of FIG. 2.

At block 202, a text encoder processes text prompts. In one example, the text encoder is a pre-trained text encoder such as CLIP used within a UNet neural network implemented on a computing device. The text encoder processes the text prompts to produce embedded text prompts for processing by the neural network.

At block 204, a diffusion model generates images based on the text prompts. In one example, the diffusion model is a pretrained SD model within a UNet neural network implemented on the computing device. The pretrained SD model is pre-trained using many text-image data pairs. In response to receiving a text prompt from the text encoder (block 202), the pretrained SD model generates an image.

At block 206, a reward model(s) implemented on the computing device iteratively determines reward scores for the generated images to convergence while the diffusion model is fixed. In one example, the reward model includes one or more aesthetic models configured to assess the quality of the images generated by the diffusion model (block 204) while the diffusion model is fixed.

At block 208, the computing device updates weights of the text encoder based on the reward scores (block 206) to fine tune the pretrained text encoder while the diffusion model is fixed. In one example, the weights of the diffusion model are fixed during the fine tuning of the pretrained text encoder.

At block 210, a reward model(s) implemented on the computing device iteratively determines reward scores to convergence for the generated images while the text encoder is fixed. In one example, the reward model includes one or more aesthetic models configured to assess the quality of the images generated by the diffusion model (block 204) while the text encoder is fixed. The reward model may be the same reward model used to determine reward scores for the generated images while the diffusion model is fixed (block 206).

At block 212, the computing device updates weights of the diffusion model based on the reward scores (block 210) while the text encoder is fixed to fine tune the pretrained diffusion model while the text encoder is fixed. In one example, the weights of the text encoder are fixed during the fine tuning of the pretrained diffusion model.

The term “digital environment,” as used herein, generally refers to an environment implemented, for example, as a stand-alone application (e.g., a personal computer or mobile application running on a computing device), as an element of an application, as a plug-in for an application, as a library function or functions, as a computing device, and/or as a cloud computing system. A digital medium environment allows the computing system to train and employ multiple neural networks and/or machine-learning models, as described herein.

Examples of the present disclosure may comprise or utilize a special purpose or general-purpose computer including computer hardware, such as, for example, one or more processors and system memory, as discussed in greater detail below. Examples within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, examples of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some examples, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Examples of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In addition, as used herein, the term “cloud computing environment” refers to an environment in which cloud computing is employed.

FIG. 3 illustrates a block diagram of an example computing device 300 that may be configured to perform one or more of the processes described above. One will appreciate that one or more computing devices, such as the computing device 300 may represent the computing devices described above. In one or more examples, the computing device 300 may be a mobile device (e.g., a mobile telephone, a smartphone, a PDA, a tablet, a laptop, a camera, a tracker, a watch, a wearable device, etc.). In some examples, the computing device 300 may be a non-mobile device (e.g., a desktop computer or another type of client device). Further, the computing device 300 may be a server device that includes cloud-based processing and storage capabilities.

As shown in FIG. 3, the computing device 300 can include one or more processor(s) 302, memory 304, a storage device 306, input/output (“I/O”) interfaces 308, and a communication interface 310, which may be communicatively coupled by way of a communication infrastructure (e.g., bus 312). While the computing device 300 is shown in FIG. 3, the components illustrated in FIG. 3 are not intended to be limiting. Additional or alternative components may be used in other examples. Furthermore, in certain examples, the computing device 300 includes fewer components than those shown in FIG. 3. Components of the computing device 300 shown in FIG. 3 will now be described in additional detail.

In particular examples, the processor(s) 302 includes hardware for executing instructions, such as those making up a computer program. As an example, and not by way of limitation, to execute instructions, the processor(s) 302 may retrieve (or fetch) the instructions from an internal register, an internal cache, memory 304, or a storage device 306 and decode and execute them.

The computing device 300 includes memory 304, which is coupled to the processor(s) 302. The memory 304 may be used for storing data, metadata, and programs for execution by the processor(s). The memory 304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 304 may be internal or distributed memory.

The computing device 300 includes a storage device 306 for storing data or instructions. As an example, and not by way of limitation, the storage device 306 can include a non-transitory storage medium described above. The storage device 306 may include a hard disk drive (HDD), solid state drive (SSD), flash memory, a Universal Serial Bus (USB) drive or a combination of these or other storage devices.

As shown, the computing device 300 includes one or more I/O interfaces 308, which are provided to allow a user to provide input to (such as user strokes), receive output from, and otherwise transfer data to and from the computing device 300. These I/O interfaces 308 may include a mouse, keypad or a keyboard, a touch screen, camera, optical scanner, network interface, modem, other known I/O devices or a combination of the I/O interfaces 308. The touch screen may be activated with a stylus or a finger.

The I/O interfaces 308 may include one or more devices for presenting output to a user, including, but not limited to, a graphics engine, a display (e.g., a display screen), one or more output drivers (e.g., display drivers), one or more audio speakers, and one or more audio drivers. In certain examples, I/O interfaces 308 are configured to provide graphical data to a display for presentation to a user. The graphical data may be representative of one or more graphical user interfaces and/or any other graphical content as may serve a particular implementation.

The computing device 300 can further include a communication interface 310. The communication interface 310 can include hardware, software, or both. The communication interface 310 provides one or more interfaces for communication (such as, for example, packet-based communication) between the computing device and one or more other computing devices or one or more networks. As an example, and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI. The computing device 300 can further include a bus 312. The bus 312 can include hardware, software, or both that connects components of computing device 300 to each other.

In the foregoing specification, the invention has been described with reference to specific example examples thereof. Various examples and aspects of the invention(s) are described with reference to details discussed herein, and the accompanying drawings illustrate the various examples. The description above and drawings are illustrative of the invention and are not to be construed as limiting the invention. Numerous specific details are described to provide a thorough understanding of various examples of the present invention.

The present invention may be embodied in other specific forms without departing from its spirit or essential characteristics. The described examples are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method for tuning a generative text-to-image neural network comprising a pre-trained text encoder and a pre-trained diffusion model, the method comprising:
processing text prompts using the pre-trained text encoder to obtain embedded text prompts;
generating images responsive to the embedded text prompts using the pre-trained diffusion model;
iteratively determining reward scores for the images to convergence with the pre-trained diffusion model fixed; and
updating weights of the pre-trained text encoder responsive to the iteratively determined reward scores.

2. The method of claim 1, further comprising:
iteratively determining reward scores for the images to convergence with the pre-trained text encoder with the updated weights fixed; and
updating weights of the pre-trained diffusion model responsive to the iteratively determined reward scores for the images to convergence with the pre-trained text encoder with the updated weights fixed.

3. The method of claim 1, wherein the iteratively determining reward scores comprises:
assessing quality of the image using an aesthetics model.

4. The method of claim 1, further comprising:
processing the images with a variational autoencoder decoder before iteratively determining the reward scores for the images.

5. The method of claim 1, wherein the iteratively determining reward scores for the images to convergence with the pre-trained diffusion model fixed comprises:
maximizing quality scores predicted by one or more reward models.

6. The method of claim 5, wherein the one or more reward models comprises an image-based reward model.

7. The method of claim 6, wherein the one or more reward models further comprises a text-image alignment-based reward model.

8. The method of claim 5, wherein the iteratively determining reward scores for the images to convergence with the pre-trained diffusion model fixed further comprises:
fixing the weights of the one or more reward models.

9. The method of claim 1, wherein the pre-trained text encoder comprises a contrastive language-image pre-training (CLIP) model and wherein the method comprises:
setting similarity of the CLIP model as an always on constraint while maintaining weights of the CLIP model greater than zero.

10. The method of claim 9, where the setting the similarity of the CLIP model as an always on constraint while maintaining the weights of the CLIP model greater than zero comprises:
maximizing cosine similarity between textual embedding by the pre-trained text encoder and image embeddings by the pre-trained diffusion model.

11. A system for tuning a generative text-to-image neural network comprising:
a pre-trained text encoder that processes text prompts to obtain embedded text prompts;
a pre-trained diffusion model that generates images responsive to the embedded text prompts; and
a reward model that iteratively determines reward scores for the images to convergence with the pre-trained diffusion model fixed;
wherein weights of the pre-trained text encoder are updated responsive to the iteratively determined reward scores.

12. The system of claim 11, wherein the reward model additionally determines reward scores for the images to convergence with the pre-trained text encoder with the updated weights fixed;
wherein weights of the pre-trained diffusion model are updated responsive to the iteratively determined reward scores for the images to convergence with the pre-trained text encoder with the updated weights fixed.

13. The system of claim 11, wherein the reward model comprises an aesthetics model that iteratively determines reward scores by assessing quality of the images.

14. The system of claim 11, further comprising:
a variational autoencoder decoder that processes the images before iteratively determining the reward scores for the images.

15. The system of claim 11, wherein the reward model iteratively determines reward scores for the images to convergence with the pre-trained diffusion model fixed by maximizing quality scores predicted by one or more reward models.

16. The system of claim 15, wherein the one or more reward models comprises an image-based reward model.

17. The system of claim 16, wherein the one or more reward models further comprises a text-image alignment-based reward model.

18. The system of claim 11, wherein the pre-trained text encoder comprises a contrastive language-image pre-training (CLIP) model having a similarity constraint set to always on and to maintain weights of the CLIP model greater than zero.

19. A non-transitory computer-readable medium comprising instructions for tuning a generative text-to-image neural network comprising a pre-trained text encoder and a pre-trained diffusion model, the instructions, when executed by a processor, configuring the generative text-to-image neural network to:
process text prompts using the pre-trained text encoder to obtain embedded text prompts;
generate images responsive to the embedded text prompts using the pre-trained diffusion model;
iteratively determine reward scores for the images to convergence with the pre-trained diffusion model fixed; and
update weights of the pre-trained text encoder responsive to the iteratively determined reward scores.

20. The non-transitory computer-readable medium of claim 19, wherein the instructions, when executed by the processor, further configure the generative text-to-image neural network to:
iteratively determine reward scores for the images to convergence with the pre-trained text encoder with the updated weights fixed; and
update weights of the pre-trained diffusion model responsive to the iteratively determined reward scores for the images to convergence with the pre-trained text encoder with the updated weights fixed.
